(19) United States
(12) Patent Application Publication
(10) Pub. No.: US 2006/0046183 A1
(43) Pub. Date: Mar. 2, 2006

(54) Photoresist formulation with surfactant additive

(76) Inventors: Wang Yueh, Portland, OR (US); Shane A. Nolen, Hillsboro, OR (US); Balijeet S. Bains, Portland, OR (US); Alison R. Noble, Hillsboro, OR (US); Rex K. Frost, Hillsboro, OR (US)

Correspondence Address: SCHWABE, WILLIAMSON & WYATT, PACWEST CENTER, SUITE 1900, 1211 S.W. FIFTH AVE., PORTLAND, OR, 97204, US

(21) Appl. No.: 10/927,984

(22) Filed: Aug. 26, 2004

(51) Int. Cl. G03C 1/76

(52) U.S. Cl. 430/270.1

(57) ABSTRACT

A composition including a photoresist formulation and a surfactant additive is described herein.

### BACKGROUND OF THE INVENTION

1. Field of the Invention

The present invention relates to, but is not limited to, electronic devices, and in particular, to the field of electronic device manufacturing.

2. Description of Related Art

In the current field of semiconductor manufacturing, a photolithography process is often used in order to form photoresist patterns on a substrate of a die or a wafer. These photoresist patterns may be used to etch circuitry and/or electronic component features onto the substrate.

A photolithography process typically involves initially depositing a photoresist formulation on top of the substrate to form a photoresist film on the substrate. A patterning mask is then placed on top of the photoresist film. The wafer (i.e., substrate) may then be exposed to an electromagnetic radiation source (e.g., light source) that generates electromagnetic radiation of specific wavelength or range of wavelengths in order to initiate chemical reactions within the exposed portions of the photoresist film. As a result of these reactions, the exposed portions becomes either removable or not removable (depending on whether the photoresist film is a positive or negative type photoresist) in subsequent processes such as a developing and rinse process. After the completion of the exposure process, a developing process that often includes the use of wash compositions, such as a developer and/or a rinse in separate developing and rinsing processes, may be performed in order to remove the removable portions of the photoresist film. As a result, a photoresist pattern is formed on top of the substrate. The formed photoresist pattern, in turn, may be subsequently used as an etching in order to form circuitry and/or electronic component features on the substrate. Although not described above, additional procedures such as baking and/or heating procedures may also be performed during the various stages of the photoresist patterning process.

Currently a variety of photoresist formations are available for purchase in the commercial market. Each of the photoresist formulation is typically identified by the wavelength of the corresponding electromagnetic radiation (e.g., light) used to exposure cure the photoresist formulation. For example, a photoresist formulation may be identified as a 365 nanometer (nm) photoresist (l-line), a 248 nm photoresist (called deep UV or DUV), a 193 nm photoresist, a 157 nm photoresist, 13.5 nanometer (extreme ultra-violet, EUV), and the like. These photoresist formulations are generally manufactured by photoresist suppliers and available to the public.

### BRIEF DESCRIPTION OF THE DRAWINGS

The present invention will be described by way of exemplary embodiments, but not limitations, illustrated in the accompanying drawings in which like references denote similar elements, and in which:

FIG. 1 illustrates a deprotect residue in accordance with some embodiments;

FIG. 2 illustrates three fluoro-surfactant structures in accordance with some embodiments; and

FIG. 3 illustrates a process for forming a photoresist pattern using a photoresist formulation with a surfactant additive.

### DETAILED DESCRIPTION OF ILLUSTRATIVE EMBODIMENTS

In the following description, for purposes of explanation, numerous details are set forth in order to provide a thorough understanding of the disclosed embodiments of the present invention. However, it will be apparent to one skilled in the art that these specific details are not required in order to practice the disclosed embodiments of the present invention. In other instances, well-known electrical structures and circuits are shown in block diagram form in order not to obscure the disclosed embodiments of the present invention.

The following description includes terms such as on, onto, on top and the like, that are used for descriptive purposes only and are not to be construed as limiting. That is, these terms are terms that are relative only to a point of reference and are not meant to be interpreted as limitations, but are instead included in the following description to facilitate understanding of the various aspects of the invention.

According to various embodiments of the invention, a novel composition that includes a photoresist formulation and a surfactant additive, and methods for using the same are provided. In various embodiments, the novel composition or combined composition may be used as part of a photolithography process for forming photoresist patterns. For the embodiments, the surfactant additive may reduce the surface tension of a wash liquid, such as a developer or a rinse, that is used during the developing stage (e.g., developing and rinsing processes) of the photolithography process.

In various embodiments, the photoresist formulation is a composition that is used to form the photoresist film on top of, for example, a substrate of a die or wafer during the early stages of the photolithography process. In some embodiments, the surfactant additive when combined with a developer or a rinse liquid may facilitate the removal of residues that may form during the photolithography process. In some embodiments, the surfactant additive, when added to a photoresist formulation, will not be bonded to the backbone of the photoresist polymer that may be included in the photoresist formulation. Note that the term “additive” as used in this description means, among other things, that the “additive” may not be bonded or chemically attached to, for example, photoresist polymers that may be present in the photoresist formulation.

For the embodiments, the residues that may be formed may be “deprotect residues” that are by-products of the exposure process that is employed during the photolithography process. Such deprotect residues may not be very soluble in solvent liquids such as the developer and/or the rinse that may be used during the developing stages of the photolithography process. Because of their insolubility, these insoluble residues may deposit all over the substrate. In such situations, the residues may prevent the proper formation of circuitry or electronic component features.

In order to prevent these residues from depositing onto the substrate and interfering with the proper formation of circuitry or electronic component features, according to various embodiments, a surfactant additive that reduces the surface tension of the developer and/or rinse liquids may be added to the photoresist formulations. Such an additive may combine with the developer and/or rinse liquids to facilitate the removal of residues from the surface of the substrate.

In various embodiments, the photoresist formulation may include, for example, photoresist polymers, photoacid generator (PAG), solvents, quenchers, and other additives. In some embodiments, the photoresist formulation may be a positive type 193 nm photoresist formulation. In other embodiments, the photoresist formulation may be other types of photoresist formulations such as 365 nanometer (nm) photoresist (l-line), a 248 nm photoresist (called deep UV or DUV), a 193 nm photoresist, 157 nm photoresist, EUV, and the like.

As described above, in various embodiments, the photoresist formulation may be a 193 nm photoresist formulation that is comprised of photoresist polymers. For the embodiments, one or more protecting groups may be randomly attached to the photoresist polymer. A protecting group, in brief, may prevent the photoresist polymer that it is attached to from dissolving in aqueous solutions such as a basic aqueous solution. However, once separated from the protecting group, the photoresist polymer may become soluble in basic aqueous solutions such as a developer.

In various embodiments, a protecting group may be severed from the photoresist polymer chain by an exposure process. If the protecting group, such as a group that is attached to a 193 nm photoresist polymer, is severed from the photoresist polymer, it may form a residue (herein “deprotect residue”) that may have a tendency to be substantially insoluble in, for example, an aqueous solution. As a result, the substantially insoluble deprotect residue may be difficult to remove from the substrate during subsequent processes (e.g., develop and rinse operations). That is, since wash liquids (e.g., developer and rinse) may be basic aqueous solutions or in the case of a rinse, purified water, deprotect residues may not be easily removed by subsequent wash or removal operations (note that for purposes of this description, the term “solution” is broadly defined and may include pure material). If allowed to remain, the deposited deprotect residues may interfere with the proper formation of circuitry or electronic components.

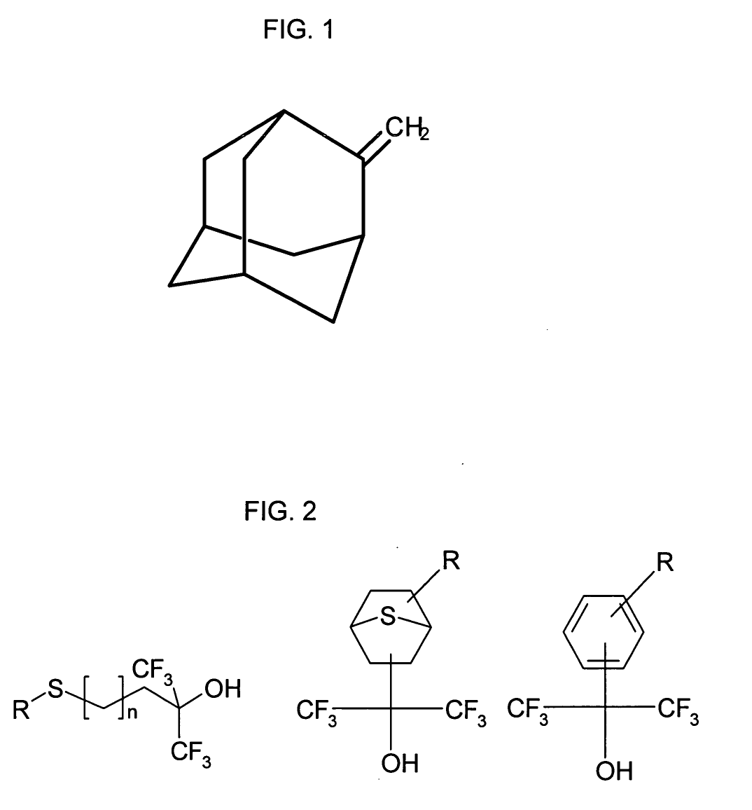

FIG. 1 depicts a deprotect residue generated from a 193 nm photoresist after an exposure process according to some embodiments. For the embodiments, the deprotect residue is 2-methylene-adamantane, which has the chemical formula of C₁₁H₁₆. Note that the chemical composition and/or structure of a deprotect residue may vary depending upon the type of photoresist formulation (e.g., a 248 nm photoresist, a 193 nm photoresist, a 157 nm photoresist, EUV photoresist, and the like) that the deprotect residue is associated with.

In various embodiments, the surfactant additive may be a fluoro-surfactant additive which may have at least three different structures as depicted in FIG. 2, a linear, a cage, or a phenyl structure. In these structures, “R” may be hydrogen, alkyl, or cage. For the embodiments, the fluoro-surfactant additive, when added to a photoresist formulation, may not be attached or bonded to the backbone of the photoresist polymers present in the photoresist formulation. In some embodiments, a surfactant additive may be added to a photoresist formulation to form a composition that may have a concentration of about 0.01 percent to about 3 percent by weight of the surfactant additive.

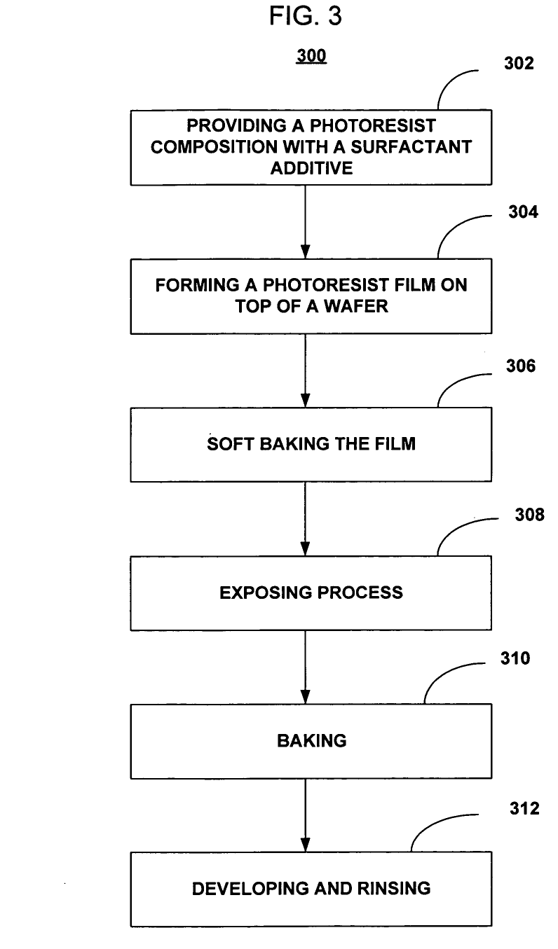

FIG. 3 depicts a photolithography process using the novel compositions described above in accordance with some embodiments. For the embodiments, the process 300 may begin when a composition that includes a photoresist formulation and a surfactant additive is provided at block 302. For the embodiments, the surfactant additive, when combined with a wash liquid such as a developer or a rinse solution, may reduce the surface tension of the wash liquid. In various embodiments, the photoresist formulation may be an EUV, a 157 nm, a 193 nm, a 248 nm or a 365 nm photoresist formulation. In some embodiments, the surfactant additive does not attach to the backbone of the photoresist polymer that may be present in the photoresist formulation.

The composition containing the photoresist formulation and the surfactant additive may be deposited onto a substrate surface to form a photoresist film on top of the substrate surface at block 304. In various embodiments, the substrate may be a wafer or die substrate. Next, a soft-bake of the film may be performed in order, for example, to remove solvents that may have been included in the photoresist formulation at block 306.

In various embodiments, an exposure process using a mask may then be performed on the photoresist film, which may initiate a chemical reaction within the exposed portions of the photoresist film at block 308. The initiated reaction may result in protecting groups being severed from photoresist polymers contained in the exposed portions of the photoresist film. As a result, the protecting groups may form resin residues (i.e., deprotect residues) that may be substantially insoluble in water or aqueous solutions.

A baking procedure may be performed to amplify the latent image formed from the preceding masking and exposure curing processes at block 310. In some embodiments, the photoresist film may be baked (i.e., post exposure bake or PEB) for about 1 to 2 minutes at 70° to 150° C.

Following the baking process, a developing process (i.e., wash process) that may involve separate developing and rinsing operations may be performed at block 312. In some embodiments, if the photoresist formulation that was used was a positive type photoresist formulation, then the exposed portions of the photoresist film may be removed. During the developing process, a developer is placed on the photoresist film followed by a rinsing process that places rinse liquids onto the photoresist film. Various methods may be used in order to apply the developer and/or rinse liquids. For example, in one embodiment, a puddle method is used to apply the developer and rinse. In the puddle method, a developer is puddled onto the substrate. The substrate is then spun to distribute the developer over the substrate surface. The developer may then be left on the substrate surface for sufficient development time to develop the photoresist pattern. A rinse may then be puddled onto the still wet substrate surface. Once the rinse has been puddled, the substrate may be spun to rinse the substrate. After the rinsing procedure, the rinsed substrate may be dried by, for example, spin-drying.

Note that in some embodiments, in lieu of or in combination with adding surfactant additives to the photoresist formulation, surfactant additives may also be added to the rinse solutions. Such an approach may assure that the deprotect residues that may form during the exposure process are removed from the surface of the substrate.

In various embodiments, the developer may be any suitable basic aqueous solution. For example, in some embodiments, an aqueous solution comprising of tetramethyl ammonium hydroxide (TMAH) may be used. Other acceptable aqueous solutions include, for example, aqueous solutions comprising trimethyl 2-hydroxyethyl ammonium hydroxide, tetraethylammonium hydroxide, tetrapropylammonium hydroxide, tetrabutylammonium hydroxide, methyltriethylammonium hydroxide, trimethylethylammonium hydroxide, dimethyldiethylammonium hydroxide, triethyl (2-hydroxyethyl) ammonium hydroxide, dimethyldi (2-hydroxyethyl) ammonium hydroxide, diethyldi (2-hydroxyethyl) ammonium hydroxide, methyltri(2-hydroxyethyl)ammonium hydroxide, ethyltri(2-hydroxyethyl)ammonium hydroxide, or tetra(2-hydroxyethyl)ammonium hydroxide.

Note that one or more of the blocks 302 to 312 illustrated in FIG. 3 may be modified or in a different sequential order than the one depicted in various other embodiments. Further, in some embodiments, one or more of the blocks 302 to 312 may be eliminated from the overall process 300. Yet further, in some embodiments, other block or blocks of operation may be added.

Although specific embodiments have been illustrated and described herein, it will be appreciated by those of ordinary skill in the art that any arrangement which is calculated to achieve the same purpose may be substituted for the specific embodiment shown. This application is intended to cover any adaptations or variations of the embodiments of the present invention. Therefore, it is manifestly intended that this invention be limited only by the claims.

1. (canceled)

2. (canceled)

3. A composition, comprising:
a photoresist formulation;
a surfactant additive; and
wherein the surfactant additive having a structure selected from the group consisting of: 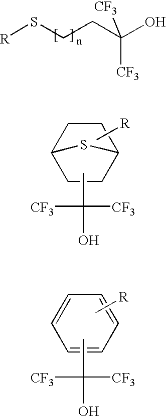
wherein R is one selected from the group consisting of hydrogen, alkyl, and cage.

4. The composition of claim 3, wherein the surfactant additive when combined with a developer dissolves a deprotect residue.

5. The composition of claim 4, wherein the deprotect residue having the structure:

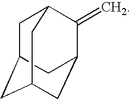

6. The composition of claim 3, wherein the photoresist formulation comprises a 193 nanometer photoresist formulation.

7. The composition of claim 3, wherein the photoresist formulation comprises a photoresist polymer with a protecting group, the protecting group when separated from the photoresist polymer forms a deprotect residue.

8. The composition of claim 7, wherein the surfactant additive is not bonded to a backbone of the photoresist polymer.

9. (canceled)

10. The method, comprising:
providing a composition comprising a photoresist formulation and a surfactant additive;
depositing the composition onto a substrate to form a photoresist film on the substrate; and
wherein said providing comprises providing a composition with a surfactant additive having a structure selected from the group consisting of: 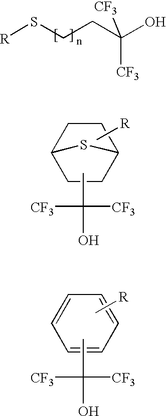
wherein R is one selected from the group consisting of hydrogen, alkyl, and cage.

11. The method of claim 10, further comprises exposing at least a portion of the photoresist film.

12. The method of claim 11, wherein said exposing comprises forming deprotect residues.

13. The method of claim 12, wherein said forming of deprotect residues comprises forming deprotect residues having the structure:

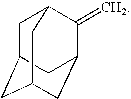

14. The method of claim 12, further comprises developing the exposed photoresist film with a developer, the developer to combine with the surfactant additive to dissolve the deprotect residues.

15. The method of claim 14, further comprises rinsing the developed photoresist film.

16. The method of claim 10, wherein said providing comprises providing a composition with photoresist polymers, the photoresist polymers having protecting groups that form deprotect residues when severed from the photoresist polymer.

17. The method of claim 10, wherein said providing comprises providing a composition with a surfactant additive that does not bond with backbone of a photoresist polymer that is present in the composition.

18. (canceled)

19. A method, comprising:
providing a photoresist formulation;
adding a surfactant additive to the photoresist formulation to form a combined composition; and
wherein said adding comprises adding a surfactant additive having a structure selected from the group consisting of: 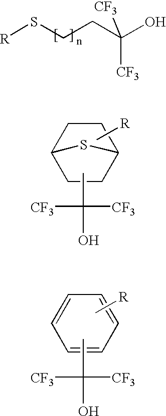
wherein R is one selected from the group consisting of hydrogen, alkyl, and cage.

20. The method of claim 19, wherein said providing comprises providing a 193 nm photoresist formulation.

21. The method of claim 19, wherein adding comprises adding a surfactant additive to be combined with a wash composition to dissolve a deprotect residue, the wash composition selected from the group consisting of a developer and a rinse.

22. The method of claim 21, wherein said deprotect residue having the structure:

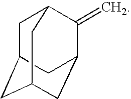

23. A composition, comprising:
a photoresist formulation;
a surfactant additive; and
wherein the surfactant additive when combined with a developer dissolves a deprotect residue, the deprotect residue having the structure:

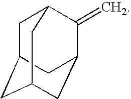

24. A method, comprising:
providing a photoresist formulation;
adding a surfactant additive to the photoresist formulation to form a combined composition; and
wherein adding comprises adding a surfactant additive to be combined with a wash composition to dissolve a deprotect residue, the wash composition selected from the group consisting of a developer and a rinse, said deprotect residue having the structure: [chemical structure]
